(19) United States
(12) Patent Application Publication
(10) Pub. No.: US 2026/0060303 A1
(43) Pub. Date: Mar. 5, 2026

(54) AEROSOL GENERATING DEVICE AND HEATING COMPONENT THEREOF

(71) Applicant: SMOORE INTERNATIONAL HOLDINGS LIMITED, George Town (KY)

(72) Inventors: Guo ZHANG, Shenzhen (CN); Lei MA, Shenzhen (CN); Hongming ZHOU, Shenzhen (CN); Rihong LI, Shenzhen (CN); Qingchen CHU, Shenzhen (CN)

(21) Appl. No.: 19/383,412

(22) Filed: Nov. 7, 2025

Related U.S. Application Data
(63) Continuation of application No. PCT/CN2024/091487, filed on May 7, 2024.

(30) Foreign Application Priority Data
May 9, 2023 (CN) 202321108614.2

(51) Int. Cl. A24F 40/46

(52) U.S. Cl. CPC A24F 40/46

(57) ABSTRACT

A heating component includes: a heating element; and a pipe body. The heating element includes a heating main body that generates infrared light in a powered-on state. The heating main body is arranged in a hollowed-out cylindrical shape and is spaced apart from the pipe body. The pipe body allows the infrared light to pass through. A transmittance of the pipe body to infrared light at wavelengths of 2-4.75 μm is more than or equal to 50%.

### CROSS-REFERENCE TO PRIOR APPLICATION

This application is a continuation of International Patent Application No. PCT/CN2024/091487, filed on May 7, 2024, which claims priority to Chinese Patent Application No. 202321108614.2, filed on May 9, 2023. The entirety of both applications is hereby incorporated by reference herein.

### FIELD

The present application relates to the field of heat-not-burn atomization, and more specifically, to an aerosol generating device and a heating component thereof.

### BACKGROUND

In the field of heat-not-burn (HNB) atomization, generally, heating methods such as central heating element heating or peripheral heating element heating are adopted. The central heating element heating method can be achieved by an aerosol generating device. The aerosol generating device includes a pipe body and a heating element arranged in the pipe body. During use, the pipe body is inserted into an aerosol-forming substrate, the heating element, in a powered-on state, generates infrared light, and the infrared light passes through the pipe body and heats the aerosol-forming substrate. In the related art, the heating element is made of a heating wire, but it has problems of certain strength and installation inconvenience.

### SUMMARY

In an embodiment, the present invention provides a heating component, comprising: a heating element; and a pipe body, wherein the heating element comprises a heating main body configured to generate infrared light in a powered-on state, wherein the heating main body is arranged in a hollowed-out cylindrical shape and is spaced apart from the pipe body, wherein the pipe body is configured to allow the infrared light to pass through, and wherein a transmittance of the pipe body to infrared light at wavelengths of 2-4.75 μm is more than or equal to 50%.

### BRIEF DESCRIPTION OF THE DRAWINGS

Subject matter of the present application will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of a heating component according to a first embodiment of the present application;

FIG. 2 is a perspective schematic structural diagram of the heating component shown in FIG. 1;

FIG. 3 is a sectional view of the heating component shown in FIG. 1;

FIG. 4 is an exploded view of the heating component shown in FIG. 1;

FIG. 5 is a schematic structural diagram of a heating component according to a second embodiment of the present application;

FIG. 6 is a sectional view of the heating component shown in FIG. 5;

FIG. 7 is a schematic structural diagram of a heating component according to a third embodiment of the present application;

FIG. 8 is a perspective schematic structural diagram of the heating component shown in FIG. 7;

FIG. 9 is a sectional view of the heating component shown in FIG. 7;

FIG. 10 is an exploded view of the heating component shown in FIG. 7;

FIG. 11 is a schematic structural diagram of a heating element shown in FIG. 10 in an unfolded state;

FIG. 12 is a schematic structural diagram of a heating component according to a fourth embodiment of the present application;

FIG. 13 is a sectional view of the heating component shown in FIG. 12 from a first angle;

FIG. 14 is a sectional view of the heating component shown in FIG. 12 from a second angle; and

FIG. 15 is an exploded view of the heating component shown in FIG. 12.

### DETAILED DESCRIPTION

In an embodiment, the present invention provides an improved aerosol generating device and a heating component thereof.

In an embodiment, the present invention provides a heating component including a heating element and a pipe body. The heating element includes a heating main body that generates infrared light in a powered-on state, the heating main body is arranged in a hollowed-out cylindrical shape and spaced apart from the pipe body, the pipe body is configured to allow the infrared light to pass through, and the transmittance of the pipe body to infrared light at the wavelengths of 2-4.75 μm is more than or equal to 50%.

Preferably, the heating main body includes a hollowed-out portion and a heating portion. The heating portion is provided with an infrared light radiating layer, and the infrared light radiating layer is arranged on the surface of the heating portion opposite to the pipe body.

Preferably, at least two heating portions are arranged, and the hollowed-out portion is located between the at least two heating portions.

Preferably, the heating portions are arranged in a strip shape, and each heating portion is arranged circumferentially.

Preferably, the heating portions are in a linear shape, a bent shape, or a spiral shape.

Preferably, the heating portions have the same shape, are arranged in parallel circumferentially, and are parallel to the central axis of the heating main body.

Preferably, at least some of the heating portions are parallel to each other; or at least some of the heating portions are inclined relative to each other; or at least some of the heating portions are intersected, or the heating portions are interlaced into a mesh.

Preferably, the heating element further includes a connection portion which electrically connects one end of the at least two heating portions.

Preferably, the heating element further includes connection portions that connect the at least two heating portions into one piece and electrically connect the at least two heating portions, and the connection portions are respectively arranged at two ends of the heating main body in the axial direction.

Preferably, the heating element further includes a conductive limiting portion configured to match the pipe body and conductively connect to the heating portion.

Preferably, the conductive limiting portion includes a limiting portion on the connection portion arranged at least on one end, and the limiting portion extends to the end away from the heating main body.

Preferably, the limiting portion includes at least two limiting jaws arranged at an interval in the circumferential direction, and the limiting jaws are in contact with the pipe wall of the pipe body.

Preferably, the limiting portion is arranged on the connection portion at one end, and the limiting portion is at least partially farther from the central axis of the heating main body than the heating portion in the radial direction.

Preferably, an accommodating cavity configured to accommodate the heating element is formed in the pipe body; and the heating element is arranged in the accommodating cavity, the heating portion is spaced apart from the pipe wall of the pipe body, and the limiting portion is in contact fit with the pipe wall.

Preferably, the pipe body includes a tubular portion and a pointed top structure arranged at one end of the tubular portion in the axial direction, and the tubular portion and the pointed top structure together define the accommodating cavity.

Preferably, the heating component further includes at least one conductive portion, and the conductive portion is connected to the limiting portion and extends out from the end of the tubular portion opposite to the pointed top structure.

Preferably, one conductive portion is arranged; the conductive limiting portion further includes a fixing hole formed on the other connection portion; the heating component further includes a conductive rod; the conductive rod is mounted in the pipe body through the fixing hole; one end of the conductive rod is abutted against and fixed to the pointed top structure; and the other end of the conductive rod extends out from the end of the tubular portion opposite to the pointed top structure.

Preferably, the fixing hole is located in the central axis of the heating main body.

Preferably, two conductive portions are arranged, one end of the two conductive portions is connected to the limiting portion, the two conductive portions are arranged at an interval, and the other end of the two conductive portions extends out from the end of the tubular portion opposite to the pointed top structure.

Preferably, the end of the tubular portion opposite to the pointed top structure is turned up, to form a turned-up portion for installation and fixation.

Preferably, the limiting portions are respectively arranged on the connection portions at two ends, and are at least partially closer to the central axis of the heating main body than the heating portion in the radial direction.

The present application further provides an aerosol generating device. The aerosol generating device includes the heating component according to the present application and a power supply component configured to supply power to the heating component.

The following beneficial effects are obtained when the aerosol generating device and the heating component thereof in the present application are implemented.

The heating main body is arranged in the hollowed-out cylindrical shape, a production mode is simple, and the heating main body may be hollowed-out according to a requirement for a temperature field. In addition, the heating main body is not easily deformed when heated. The perpendicularity of the heating main body can be relatively well ensured, installation is relatively simple, the heating main body and the pipe wall can be ensured to be arranged at an interval, and heating is more uniform, thereby improving experience of a consumer.

In the accompanying drawings, 10: heating component; 1: heating element; 11: heating main body; 111: heating portion; 1111: vertical portion; 1112: bent portion; 112: hollowed-out portion; 12: connection portion; 121: fixing hole; 13: limiting portion; 131: limiting jaw; 14: conductive portion; 15: conductive rod; 16: turned-up portion; 2: pipe body; 21: accommodating cavity; 22: tubular portion; 23: pointed top structure; 31: first pipe body; 32: second pipe body; 33: first accommodating cavity; 34: second accommodating cavity; 35: thermal insulation gap; 36: reflective layer; 37: mounting base; 371: through hole; 372: first spacing edge; and 373: second spacing edge.

To provide a clearer understanding of the technical features, objectives, and effects of the present application, specific implementations of the present application are described in detail with reference to the accompanying drawings. In the following description, it should be understood that orientation or position relationships indicated by the terms such as “rear”, “up”, “transverse”, “vertical”, “top”, “inner”, and “outer” are based on orientation or position relationships illustrated in the accompanying drawings, constructed and operated in a particular orientation, and merely intended to facilitate the description of the technical solution, instead of indicating that the device or element referred to needs to have a particular orientation. Thus, such terms should not be interpreted as limiting the present application.

It should be further noted that, unless otherwise clearly specified and limited, terms such as “mounted”, “connected to”, “connected”, “fixed”, and “arranged” should be understood in a generalized manner, for example, connection may be understood as a fixed connection, a detachable connection, or integration, or may be understood as a mechanical connection or an electrical connection, or may be understood as a direct connection, an indirect connection via a medium, an internal communication of two elements, or an interaction relationship between two elements. When an element is referred to as being “above” or “below” another element, the element can be “directly” or “indirectly” located above the another element, or one or more intervening elements may exist. The terms such as “first”, “second”, and “third” are merely for facilitating the description of the technical solution, and should not be interpreted as indicating or implying relative importance or implicitly indicating the number of the technical features indicated. Thus, the features defined with “first”, “second”, and “third” can explicitly or implicitly include one or more of such features. Those of ordinary skill in the art may understand the specific meanings of the foregoing terms in the present application according to specific situations.

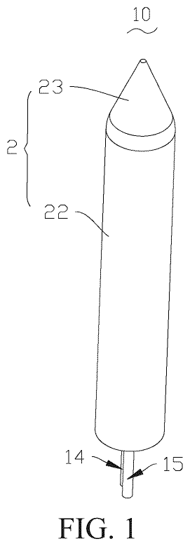

FIG. 1 shows a heating component 10 according to a first embodiment of the present application. The heating component 10 may generate infrared light in a powered-on state, and radiates the infrared light to an aerosol-forming substrate, to heat the aerosol-forming substrate. The aerosol-forming substrate may be cylindrical. Specifically, the aerosol-forming substrate may be a solid material that is in a string shape, a sheet shape, or an integrally formed shape and that is made of leaves and/or stalks of plants (such as tobacco), and an aroma component may be further added to the solid material.

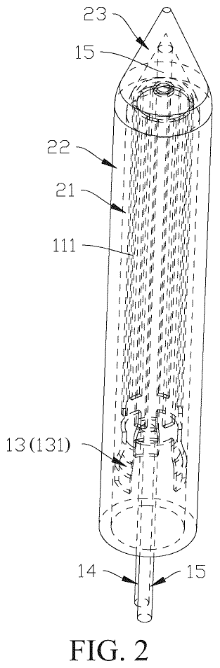

As shown in FIG. 1 to FIG. 4, the heating component 10 may include a heating element 1 that generates infrared light in a powered-on state and a pipe body 2. The heating element 1 is spaced apart from the pipe body 2. The pipe body 2 is configured to allow the infrared light to pass through. The heating element 1 includes a heating main body 11 that generates infrared light in a powered-on state, and the heating main body 11 is arranged in a hollowed-out cylindrical shape. In this embodiment, the heating main body 11 of the heating component 10 is arranged in the hollowed-out cylindrical shape, a production mode is simple, the heating main body may be hollowed-out according to a requirement for a temperature field, the heating main body is not easily deformed when heated, the perpendicularity of the heating main body 1 may be relatively well ensured, a possibility of being adhered to the pipe wall is reduced, and the heating is more uniform and stable, thereby improving experience of a consumer. It should be noted that, the cross section of the pipe body 2 in this solution may be circular, triangular, oval, or in any other shape.

The heating main body 11 is arranged in the hollowed-out cylindrical shape. In this embodiment, the heating main body 11 may include a heating portion 111 and a hollowed-out portion 112. It may be understood that the heating portion 111 may generate infrared light in a powered-on state to heat the aerosol-forming substrate. The hollowed-out portion 112 is formed on the cylindrical main body, to form the heating portion 111. It should be noted that, in some embodiments, the cylindrical shape refers to a strip or column structure that is longitudinally arranged and has a gap inside. In other words, at least two circumferential surfaces in the circumferential direction are provided.

The heating portion 111 may be provided with an infrared light radiating layer, whereby the heating portion 111 may generate, in the powered-on state, the infrared light; and the infrared light radiating layer is arranged on the surface of the heating portion 111 opposite to the pipe body 2. Specifically, the heating portion 111 may include a heating substrate and an infrared light radiating layer arranged on the outer surface of the heating substrate. The heating substrate is electrically heated and configured to excite infrared light.

In some embodiments, the heating portion 111 includes a heating substrate and an infrared radiating layer which coats the heating substrate, the heating substrate includes a metal substrate with high-temperature oxidation resistance, and the heating substrate may be a metal material with good high-temperature oxidation resistance, high stability, and low tendency to deform, such as a nickel-chromium alloy matrix or an iron-chromium-aluminum alloy matrix.

In some embodiments, the heating portion 111 further includes an anti-oxidation layer, and the anti-oxidation layer is formed between the heating substrate and the infrared radiating layer. Specifically, the anti-oxidation layer may be an oxidation film. The heating substrate is subject to high-temperature heat treatment and generates a dense oxidation film on its surface, and the oxidation film forms the anti-oxidation layer. Certainly, it may be understood that, in some other embodiments, the anti-oxidation layer is not limited to the oxidation film formed on the heating substrate itself. In some other embodiments, the anti-oxidation layer may be an anti-oxidation coating applied to the outer surface of the heating substrate. The thickness of the anti-oxidation layer may be selected to be 1 μm to 150 μm. It may be understood that the thickness of the anti-oxidation layer may be selected to be 1 μm, 150 μm, and any value between 1 μm and 150 μm.

In some embodiments, the infrared radiating layer may be an infrared layer. The infrared layer may be an infrared layer-forming substrate that is formed, through high-temperature heat treatment, on the side of the anti-oxidation layer away from the heating substrate. Specifically, the infrared layer-forming substrate may be a silicon carbide substrate, a spinel substrate, or a composite substrate thereof. Certainly, it may be understood that, in some other embodiments, the infrared radiating layer is not limited to the infrared layer. In some other embodiments, the infrared radiating layer may be a composite infrared layer. Specifically, the infrared layer may be formed on the side of the anti-oxidation layer away from the heating substrate by a method such as dipping, spraying, or brushing. The thickness of the infrared radiating layer may be 10 μm to 300 μm. It may be understood that the thickness of the infrared radiating layer may be 10 μm, 300 μm, or any value between 10 μm and 300 μm.

It may be understood that, a location where the heating portion 111 is arranged can generate infrared light in a powered-on state to heat the aerosol-forming substrate. Therefore, related parameters such as shapes, the number, and dimensions of the heating portion 111 and the hollowed-out portion 112 may be set according to a requirement for temperature field distribution. In the prior art, a heating element with a spiral structure has a problem of low consistency of a heating structure, which affects temperature distribution of the heating structure. However, the hollowed-out cylindrical structure in the present application does not have the above drawbacks, is easier to process, and is more beneficial to temperature control.

In this embodiment, at least two heating portions 111 may be included, and the hollowed-out portion 112 may be located between the at least two heating portions 111. It may be understood that, the number of the heating portion 111 may be set according to the shape and dimension of the heating portion 111. When the dimension of the heating portion 111 is changed, that is, the magnitude of the resistance value and the infrared irradiating area of the heating portion 111 are changed, a heating condition is changed.

In this embodiment, the heating portions 111 may be arranged in a strip shape. Certainly, in other embodiments, the heating portions 111 may alternatively be arranged in another shape such as a block, a sheet, a wire, or a rod.

The heating portions 111 may be in a linear shape, a bent shape, or a spiral shape. It may be understood that, in the same heating main body 11, the shapes of the heating portions 111 may be the same or different. That is, the heating portions 111 in one heating main body 11 may be arranged in one shape or by combining various shapes. In this embodiment, the heating portions 111 may be arranged in the same shape. It may be understood that, if only the shape factor of the heating portions 111 is considered, when the heating portions 111 in one heating main body 11 are arranged in the same shape, the temperature field of the heating main body 11 may be more uniform.

The heating portions 111 may be in a bent shape. Specifically, the heating portions 111 are at least partially bent, and the heating portions 111 have one or more bent segments. The heating portions 111 may be bent into a spring shape, a lightning shape, an S shape, or a C shape. These variable shapes may be configured to design regions and areas of different temperature fields and infrared radiation, so as to achieve different temperature control objectives.

It may be understood that when the heating portion 111 has a plurality of bent segments, the temperature field distribution is related to the density level of the plurality of bent segments, and the density level of the plurality of bent segments of the heating portion 111 may be set according to a requirement for the temperature field. For example, along the extension path of the heating portion 111, the plurality of bent segments may be distributed equally, or the plurality of bent segments may be distributed densely and sparsely alternately, or the plurality of bent segments may be distributed sparsely first and then densely, or the plurality of bent segments may be distributed densely first and then sparsely, or the plurality of bent segments may be distributed sparsely first, then densely, and sparsely finally, or the plurality of bent segments may be distributed densely first, then sparsely, and densely finally.

The heating portion 111 may be in the spiral shape. Specifically, the heating portion 111 spirally extends around the central axis of the heating element 1 in the circumferential direction, and is entirely in the spiral shape. It may be understood that, the spiral heating portion 111 is formed by means of hollowing out. In other embodiments, the heating portion 111 may alternatively be arranged in another shape such as a ring. It may be understood that, in this embodiment, the central axis of the heating main body 11 and the central axis of the heating element 1 are located in the same axis.

The heating portions 111 may be parallel to each other, inclined relative to each other, or intersected. In addition, the heating portions 111 may be entirely arranged parallel to the central axis of the heating main body 11, perpendicular to the central axis of the heating main body 11, or at an oblique angle with the heating main body 11.

In a specific implementation, the heating portions 111 in one heating main body 11 may be arranged in such a manner that at least some of the heating portions 111 are parallel to each other, including: some of the heating portions 111 are parallel to each other, or all of the heating portions 111 are parallel to each other. In this case, the hollowed-out portion 112 is located between two heating portions 111 that are parallel and adjacent to each other, and the hollowed-out portion 112 may completely separate the two heating portions 111.

Alternatively, the heating portions 111 in one heating main body 11 may be arranged in such a manner that at least some of the heating portions 111 are inclined relative to each other, including: some of the heating portions 111 are inclined relative to each other, or all of the heating portions 111 are inclined relative to each other. In this case, the hollowed-out portion 112 is located between two heating portions 111 that are inclined relative to each other and adjacent to each other, and the hollowed-out portion 112 may completely separate the two heating portions 111.

Alternatively, the heating portions 111 in one heating main body 11 may be arranged in such a manner that at least some of the heating portions 111 are intersected, including: some of the heating portions 111 are intersected, or all of the heating portions 111 are interlaced together. In this case, the hollowed-out portion 112 is located between two intersected heating portions 111, and separates parts of the two heating portions 111. It may be understood that, parts of the heating portions 111 are intersected, and may be, for example, arranged in a grid shape; and all the heating portions 111 are interlaced. For example, the heating portions 111 are interlaced into a mesh.

It may be understood that, if only the arrangement manner of the heating portions 111 is considered, when the heating portions 111 in one heating main body 11 are set in one manner, the temperature field of the heating main body 11 may be more uniform. For example, when the heating portions 111 in one heating main body 11 are arranged in a mutual parallel manner, that is, two adjacent heating portions 111 are separated through a hollowed-out portion 112, the temperature field of the heating main body 11 may be more uniform.

Certainly, in other embodiments, the heating portions 111 in one heating main body 11 may be arranged by combining a plurality of manners, for example, by combining at least two of parallel, inclined, and intersected manners.

The dimensions of the heating portions 111 may be the same, and the dimensions of the hollowed-out portions 112 may be the same. It may be understood that, if only the dimensional factor of the heating portions 111 is considered, when the heating portions 111 in one heating main body 11 have the same dimension and the hollowed-out portions 112 have the same dimension, the temperature field of the heating main body 11 may be more uniform.

It may be understood that, by changing the local dimension of the heating portion 111 and the local dimension of the hollowed-out portion 112, the local dimension of the heating portion 111 may be the local width of the heating portion 111, and the local dimension of the hollowed-out portion 112 may be the local width of the hollowed-out portion 112, to change the temperature difference between different locations of the heating portion 111, thereby adjusting the local temperature difference to refine a vaping experience design.

In this embodiment, the heating portions 111 may be distributed in the circumferential direction. It may be understood that, the heating portions 111 are arranged in the circumferential direction, so as to heat the aerosol-forming substrate in the circumferential direction. Certainly, in other embodiments, the heating portions 111 may be distributed in the axial direction, or the heating portions 111 are distributed in both the axial direction and the longitudinal direction.

It may be understood that, in this embodiment, a metal cylinder may be used, and the side wall of the metal cylinder is hollowed out to form the heating main body 11 in the hollowed-out cylindrical shape, and the hollowing out may be implemented by means of punching, laser, engraving, or the like. Certainly, in other embodiments, a meshed cylinder may be formed by braiding a heating wire, to form the heating main body 11 in the hollowed-out cylindrical shape.

The heating main body 11 is arranged in the hollowed-out cylindrical shape. In this embodiment, the heating main body 11 may be circular in the cross section, namely, in the hollowed-out cylindrical shape. In other embodiments, the cross section of the heating main body 11 may be in any other shape.

In this embodiment, at least two heating portions 111 are arranged. Preferably, the heating portions 111 have the same shape, the heating portions 111 are arranged in parallel in the circumferential direction, and the heating portions 111 are parallel to the central axis of the heating main body 11, whereby the temperature field is relatively uniform. It may be understood that the parallel arrangement includes that the heating portions 111 are distributed at an interval in parallel.

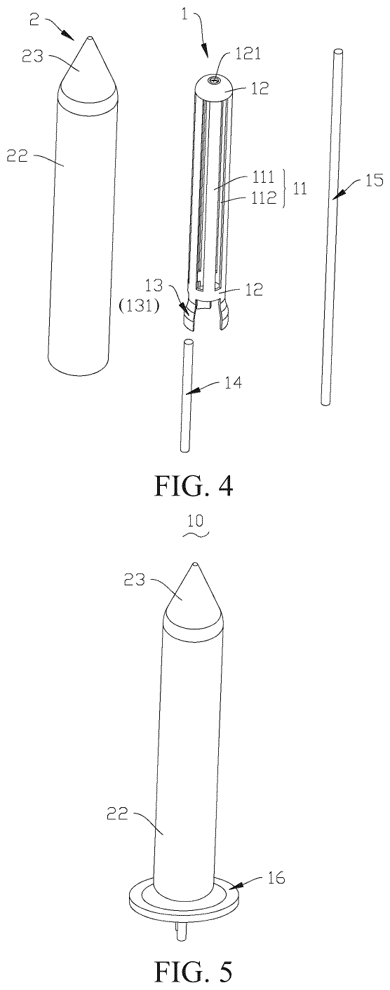

In a specific implementation of this embodiment, as shown in FIG. 4, a plurality of heating portions 111 are arranged. The heating portions 111 are in a linear shape. The heating portions 111 are parallel to each other and are parallel to the central axis of the heating main body 1. The heating portions 111 are distributed in the circumferential direction. The heating portions 111 have the same dimension, and the hollowed-out portions 112 have the same dimension, that is, the heating portions 111 are evenly distributed in the circumferential direction.

Each of the heating portions 111 has two opposite ends in the axial direction. The two ends may be respectively parallel to the axis of the heating main body 11 in the radial direction. The same ends of the heating portions 111 are located at the same axial position. It may be understood that, the temperature field distribution of the heating main body 11 in the circumferential direction is relatively uniform, to avoid an excessively high local temperature.

The heating element 1 further includes connection portions 12 that connect the at least two heating portions 111 into one piece and electrically connect the at least two heating portions 111, and the connection portions 12 may be respectively arranged at two ends of the heating main body 11 in the axial direction. In this embodiment, two connection portions 12 may be included. The two connection portions 12 are respectively arranged at two ends of the heating main body 11 in the axial direction, and respectively connect the same end of all the heating portions 111 into one piece, so as to supply power to the heating main body 11. The connection portion 12 close to a pointed top structure 23 may be configured as an arc surface, and the connection portion 12 away from the pointed top structure 23 may be arranged in a ring shape.

The heating element 1 further includes a conductive limiting portion configured to match the pipe body 2 and conductively connect to the heating portion 111. The conductive limiting portion includes a limiting portion 13 on the connection portion 12 at least arranged on one end, the limiting portion 13 is configured for limiting fit with the pipe body 2, and the limiting portion 13 extends to the end away from the heating main body 11.

In this embodiment, substrate segments in the aerosol-forming substrate may be heated by a central heating method. Specifically, the heating element 1 is arranged in the pipe body 2. The pipe body 2 is configured to allow infrared light to pass through. The pipe body 2 may be a quartz glass pipe or a pipe body 2 that is made of other window materials, such as an infrared transmitting glass pipe, a transparent ceramic pipe, or a diamond pipe, that allow light waves to pass through. The transmittance of the pipe body to infrared light at the wavelengths of 2-4.75 μm is more than or equal to 50%. It may be understood that, the transmittance of the pipe body to infrared light at the wavelengths of 2 μm, 4.75 μm, and any value between 2 μm and 4.75 μm is more than or equal to 50%.

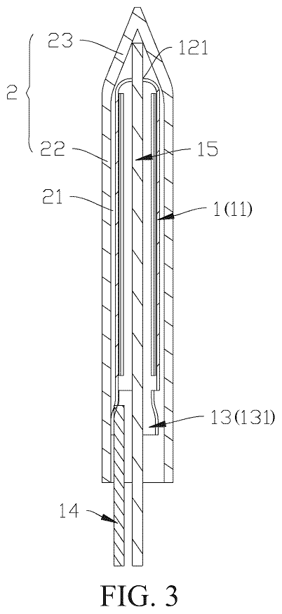

As shown in FIG. 3, an accommodating cavity 21 for accommodating the heating element 1 is formed in the pipe body 2, and the heating element 1 is arranged in the accommodating cavity 21. The limiting portion 13 is arranged on the connection portion 12 at one end, and the limiting portion 13 is at least partially farther from the central axis of the heating main body 11 than the heating portion 111 in the radial direction. When the heating element 1 is arranged in the accommodating cavity 21, the heating portion 111 is spaced apart from the pipe wall of the pipe body 2, and the limiting portion 13 is in contact fit with the pipe wall of the pipe body 2.

In this embodiment, the limiting portion 13 may be connected to the connection portion 12 away from the pointed top structure 23. The dimension of the limiting portion 13 may be set based on the dimension of the pipe body 2, whereby the heating portion 111 is spaced apart from the pipe wall of the pipe body 2, and the surface of the limiting portion 13 is in contact with the pipe wall of the pipe body 2. The limiting portion 13 may first extend outward in the axial direction from the connection portion 12 to the end away from the heating main body 11, and then continue to extend in the axial direction.

The pipe body 2 may include a tubular portion 22 and the pinpointed top structure 23 arranged on one end of the tubular portion 22 in the axial direction. The tubular portion 22 and the pointed top structure 23 may be both hollow, and the tubular portion 22 and the pointed top structure 23 together define the accommodating cavity 21. The tubular portion 22 may be arranged in a cylindrical shape, the pipe wall of the tubular portion 22 is configured as an arc surface, and the surface of the limiting portion 13 that is configured to match the pipe wall of the pipe body 2 is configured as an arc surface matching the pipe wall of the pipe body 2. That is, the surface of the limiting portion 13 away from the central axis of the heating main body 11 is configured as the arc surface.

The limiting portion 13 may include at least two limiting jaws 131 that are arranged at an interval in the circumferential direction. In this embodiment, the limiting portion 13 may include three limiting jaws 131 that are arranged at intervals in the circumferential direction. The three limiting jaws 131 have the same structure and may be evenly distributed. The three limiting jaws 131 are equidistant from the central axis of the heating main body 11. Therefore, the three limiting jaws 131 match the inner pipe wall of the tubular portion 22 together, to fix one end of the heating element 1 in the pipe body 2. In other embodiments, the limiting portion 13 may be arranged in a cylindrical shape and may be circular in the cross section. The limiting portion 13 may be made of a material with elastic properties, so as to match the pipe body 2.

The heating component 10 further includes at least one conductive portion 14. The conductive portion 14 is connected to the limiting portion 13 and extends out from the end of the tubular portion 22 opposite to the pointed top structure 23. In this embodiment, one conductive portion 14 is arranged, and the conductive portion 14 is in conductive connection with the limiting portion 13. The conductive portion 14 may be connected to one of the limiting jaws 131, to form one end of an electrode. The conductive portion 14 may be connected to the side of the limiting jaw 131 close to the central axis of the heating main body 11. The conductive portion 14 may be a leading wire and may be welded to the limiting portion 13. Of course, it may be understood that, in other embodiments, the conductive portion 14 is not limited to the leading wire, and may be other conductive structures.

In this embodiment, the conductive limiting portion further includes a fixing hole 121 formed on the other connection portion 12. That is, the fixing hole 121 is formed on the connection portion 12 close to the pointed top structure 23. The heating component 10 further includes a conductive rod 15, the conductive rod 15 is mounted in the pipe body 2 through the fixing hole 121, one end of the conductive rod 15 is abutted against and fixed to the pointed top structure 23, and the other end of the conductive rod 15 extends out from the end of the tubular portion 22 opposite to the pointed top structure 23.

The conductive rod 15 matches the fixing hole 121. The cross section of the conductive rod 15 may be circular, and the fixing hole 121 may be circular, and the diameters of the conductive rod and the fixing holes are approximately the same. The conductive rod 15 passes through the fixing hole 121 and can only move axially in the fixing hole 121, to prevent the conductive rod 15 from moving in the radial direction, thereby limiting the conductive rod 15.

The end of the conductive rod 15 close to the pointed top structure 23 is abutted against the pointed top structure 23, to fix the conductive rod 15, and further fix the other end of the heating element 1 in the pipe body 2. The other end of the conductive rod 15 extends out from the end of the tubular portion 22 opposite to the pointed top structure 23, to form the other end of the electrode. The conductive portion 14 and the conductive rod 15 extend out from the pipe body 2, to provide convenience for a power supply component to supply power to the heating component 111. The conductive rod 15 may be made of a material with low thermal conductivity.

In this embodiment, the fixing hole 121 may be located in the central axis of the heating main body 11, and the conductive rod 15 is arranged in the center. Therefore, the distance between each heating portion 111 and the pipe wall of the pipe body 2 is the same, that is, a uniform gap is formed between each heating portion 111 and the pipe wall, whereby the temperature field distribution on the outer surface of the pipe body 2 is relatively uniform.

In this embodiment, during use of the heating component 10, the pipe body 2 is inserted into the aerosol-forming substrate through the pointed top structure 23, the heating element 1 generates infrared light in a powered-on state, and the infrared light passes through the pipe body 2 to the aerosol-forming substrate and heats the aerosol-forming substrate. The temperature field distribution of the heating element 1 is uniform, such that an atomization effect is good; and the heating element 1 is not easily deformed, to ensure normal use of the heating element 1 and ensure vaping experience, thereby improving experience of a consumer.

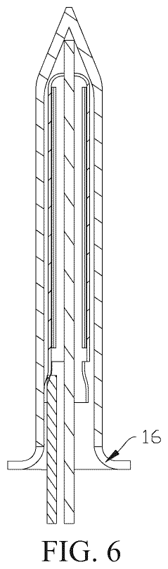

FIG. 5 shows a heating component 10 according to a second embodiment of the present application. As shown in FIG. 5 and FIG. 6, the heating component 10 differs from the heating component 10 according to the first embodiment in that the end of a tubular portion 22 opposite to a pointed top structure 23 is turned up, to form a turned-up portion 16 configured for installation and fixation, the heating component 10 may be mounted and positioned in an aerosol generating device through the turned-up portion 16, without an additional fixing portion. In other embodiments, the end of the tubular portion 22 opposite to the pointed top structure 23 is provided with a fixing portion, and the heating component is mounted and positioned through the fixing portion.

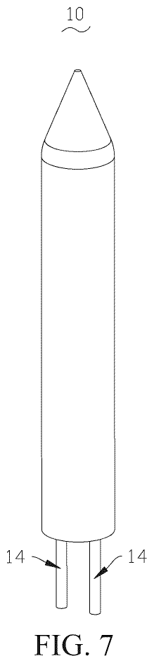

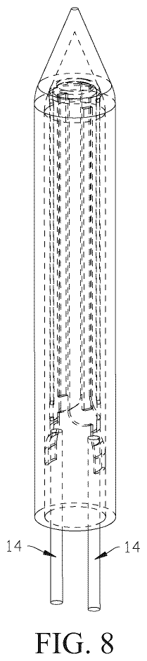

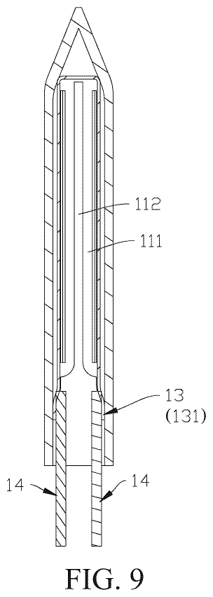

FIG. 7 shows a heating component 10 according to a third embodiment of the present application. As shown in FIG. 7 to FIG. 11, the heating component 10 differs from the heating component 10 according to the first embodiment in arrangement manners of a heating main body 11, a connection portion 12, a conductive limiting portion, and a conductive portion 14.

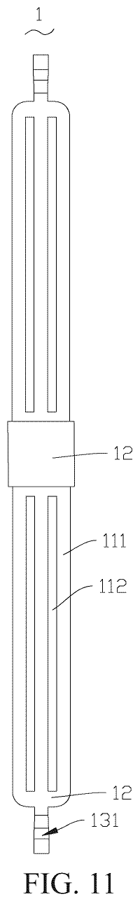

Specifically, in this embodiment, a heating element 1 may be arranged in a folded manner. As shown in FIG. 11, when the heating element 1 is unfolded, the heating element 1 may include two groups of heating portions 111. Each group of heating portion 111 includes three heating portions 111 that are parallel to each other, and the three heating portions 111 have the same dimension. The three heating portions 111 are spaced through two hollowed-out portions 112. The two hollowed-out portions 112 have the same dimension which is smaller than the dimension of the heating portions 111.

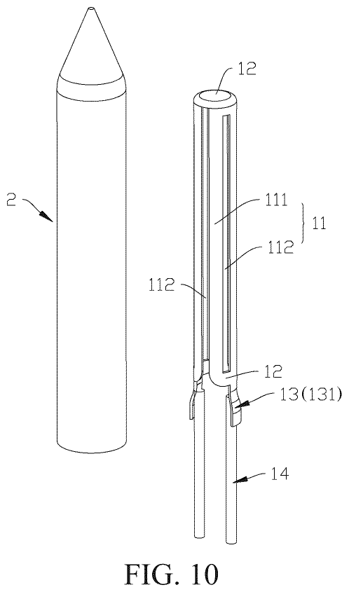

The two groups of heating portions 111 are correspondingly arranged in a linear shape. One connection portion 12 is connected between the two groups of heating portions 111, and another connection portion 12 connects the other end of the three heating portions 111 in each group of heating portion 111 together. As shown in FIG. 10, the heating element 1 is folded, such that a pointed top structure 23 corresponds to a pointed top location, and the two groups of heating portions 111 jointly enclose a cylinder, to form a hollowed-out cylindrical shape. Hollowed-out portions 112 exist between the two groups of heating portions 111.

It may be understood that, when the heating element 1 is folded, the connection portions 12 are respectively arranged at two ends of the heating main body 11 in the axial direction, one connection portion 12 is arranged close to the pointed top structure 23, and this connection portion 12 connects the same ends of all the heating portions 111 into one piece. This connection portion 12 may be arranged in a planar manner, and a fixing hole 121 and a conductive rod 15 are not required.

At least two connection portions 12 away from the pointed top structure 23 may be arranged, and the number of connection portions 12 at this end may be the same as the number of groups of the heating portions 111. In a specific implementation of this embodiment, two groups of heating portions 111 may be included, each group of connection portions 12 may include three connection portions 12, and two connection portions 12 at this end are respectively configured to connect the same ends of the same group of heating portions 111 together.

A limiting jaw 131 in the conductive limiting portion is arranged on the connection portion 12 away from the pointed top structure 23, and two limiting jaws 131 may be arranged. The two limiting jaws 131 are respectively connected to two connection portions 12 in a one-to-one correspondence manner. Two conductive portions 14 are arranged, one end of the two conductive portions 14 is connected to the two limiting jaws 131, the two conductive portions 14 are arranged at an interval, and the other end of the two conductive portions 14 extends out from the end of a tubular portion 22 opposite to the pointed top structure 23.

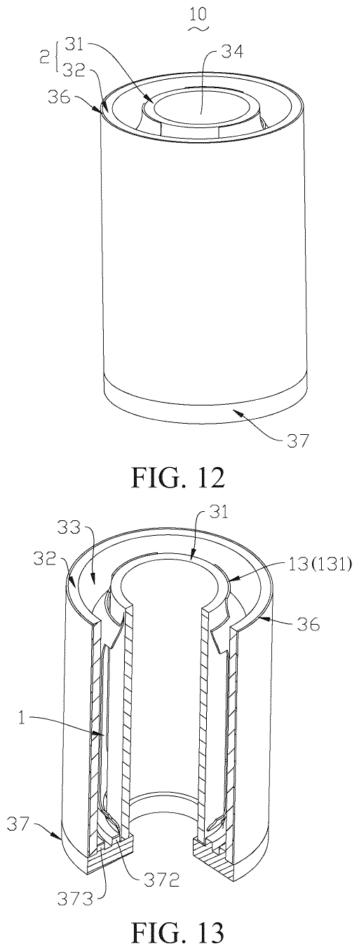

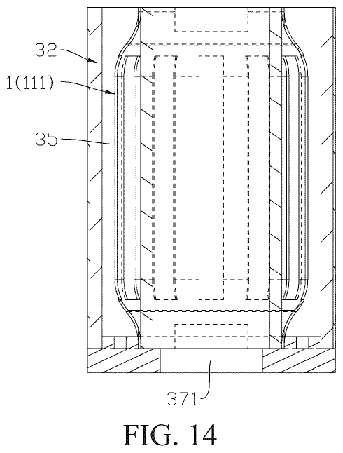

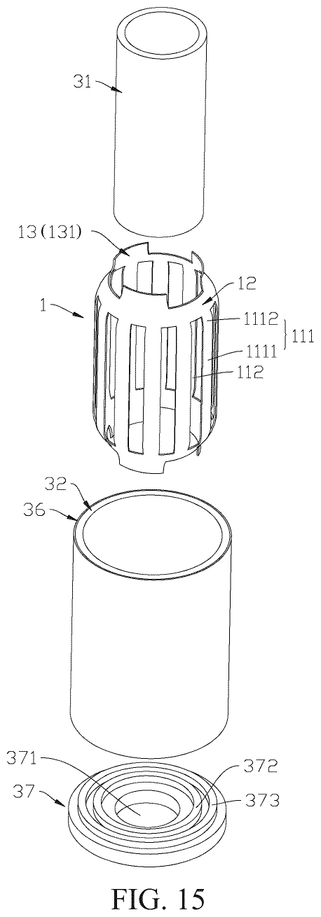

FIG. 12 shows a heating component 10 according to a fourth embodiment of the present application. As shown in FIG. 12 to FIG. 15, the heating component 10 differs from the heating component 10 according to the first embodiment in arrangement manners of a heating main body 11, a connection portion 12, a conductive limiting portion, and a pipe body 2.

Specifically, in this embodiment, two connection portions 12 may be both arranged in a ring shape. Limiting portions 13 of the conductive limiting portion may be respectively arranged on connection portions 12 at two ends, and the limiting portions 13 are at least partially closer to the central axis of the heating main body 11 than heating portions 111 in the radial direction. The limiting portions 13 may extend inwards in the axial direction from the connection portions 12 to the end away from the heating main body 11. Alternatively, the limiting portions 13 may extend inwards in the axial direction from the connection portions 12 to the end away from the heating main body 11 first, and then continue to extend in the axial direction.

In this embodiment, two limiting portions 13 may be respectively used as two electrodes, and a fixing hole 121, a conductive rod 15, and a conductive portion 14 are not required.

The connection portion 12 extends inward while extending in the axial direction from the end connected to the heating portion 111 to the end for connection to the limiting portion 13. The connection portion 12 may be obliquely arranged relative to the central axis of the heating main body 11. The heating portion 111 axially includes a vertical portion 1111 and bent portions 1112 located at two ends of the vertical portion 1111. The vertical portion 1111 is farther from the central axis of the heating main body 11 than the bent portions 1112. The bent portions 1112 connect the vertical portion 1111 and the connection portions 12. It may be understood that smooth transition is achieved between the heating portion 111 and the connection portions 12, and between the connection portions 12 and the limiting portions 13.

In this embodiment, a heating element 1 may be sleeved on the periphery of an aerosol-forming substrate and heats substrate segments of the aerosol-forming substrate by a peripheral heating method. Specifically, a pipe body 2 includes a first pipe body 31 and a second pipe body 32 that are transparent to infrared light. The first pipe body 31 may be a hollow structure with two ends open. The first pipe body 31 may be cylindrical, and the inner diameter of the first pipe body 31 may be slightly greater than the outer diameter of the aerosol-forming substrate.

A second accommodating cavity 34 may be formed on the inner side of the first pipe body 31 and is configured to accommodate the aerosol-forming substrate and form a heating space allowing the substrate segments of the aerosol-forming substrate to be heated. The first pipe body 31 may be a quartz glass pipe, an infrared transparent glass pipe, a transparent ceramic pipe, or a diamond pipe.

The second pipe body 32 may be a hollow structure with two ends open. The second pipe body 32 may be cylindrical. The axial length of the second pipe body 32 may be the same as the axial length of the first pipe body 31. The second pipe body 32 is sleeved on the periphery of the first pipe body 31. The inner diameter of the second pipe body 32 may be greater than the outer diameter of the first pipe body 31, whereby the second pipe body 32 and the first pipe body 31 are arranged at an interval, to form a first accommodating cavity 33 accommodating the heating element 1.

The heating element 1 is arranged in the first accommodating cavity 33, the heating portion 111 is at least partially spaced apart from the pipe wall of the first pipe body 31, and the limiting portion 13 is in contact fit with the pipe wall of the first pipe body 31. The limiting portion 13 of the heating element 1 is in contact fit with the outer pipe wall of the first pipe body 31. The heating portion 111 and the connection portions 12 of the heating element 1 have gaps with the outer pipe wall of the first pipe body 31 in the radial direction, that is, the heating element 1 is entirely spaced apart from the first pipe body 31. In other embodiments, the heating element 1 may be partially spaced apart from the first pipe body 31.

The heating portion 111 is spaced apart from the pipe wall of the second pipe body 32, to form a thermal insulation gap 35, to achieve a thermal insulation function and reduce the temperature of the second pipe body 32. The heating portion 111 may be entirely spaced apart from the second pipe body 32. In other embodiments, the heating portion 111 may be partially spaced apart from the second pipe body 32.

A reflective layer 36 for reflecting infrared light is arranged on the pipe wall of the second pipe body 32. The reflective layer 36 may be arranged on the inner pipe wall and/or the outer pipe wall of the second pipe body 32, and is configured to reflect the heat of the heating element 1 and radiate the heat to the aerosol-forming substrate, thereby enhancing the heating energy efficiency and reducing an external temperature field. In this embodiment, the reflective layer 36 may be arranged on the outer pipe wall of the second pipe body 32.

The pipe body 2 may further include a mounting base 37 configured to integrate the first pipe body 31, the second pipe body 32, and the heating element 1 into one piece. The mounting base 37 may be arranged at one end of the first pipe body 31 and the second pipe body 32 in the axial direction. The cross-sectional shape of the mounting base 37 may match the cross-sectional shape of the second pipe body 32. The mounting base 37 may have a circular pie shape, and the radial dimension of the mounting base 37 is at least not less than the radial dimension of the second pipe body 32. The radial dimension of the mounting base 37 may be the same as the radial dimension of the second pipe body 32 provided with the reflective layer 36.

The mounting base 37 may be provided with a through hole 371 communicated with the interior of the first pipe body 31. The through hole 371 may be located in the central axis of the mounting base 37. Central axes of the first pipe body 31, the second pipe body 32, and the mounting base 37 are located in the same axis. The through hole 371 may be slightly smaller than the inner diameter of the first pipe body 31 or equal to the inner diameter of the first pipe body 31.

The mounting base 37 is provided with a first spacing edge 372 and a second spacing edge 373. The first spacing edge 372 is arranged close to the central axis of the mounting base 37, and the first spacing edge 372 may be slightly farther from the central axis of the mounting base 37 than the outer wall surface of the first pipe body 31, to allow the limiting portion 13 to be arranged between the first spacing edge 372 and the first pipe body 31, thereby limiting the first pipe body 31 and the limiting portion 13 together.

The second spacing edge 373 is spaced apart from the first spacing edge 372, and the second spacing edge 373 is farther from the central axis of the mounting base 37 than the first spacing edge 372. A space for mounting the second pipe body 32 and the reflective layer 36 is defined between the second spacing edge 373 and the outer edge of the mounting base 37. It may be understood that, the mounting base 37 may limit positions of the first pipe body 31, the limiting portion 13, the second pipe body 32, and the reflective layer 36 through the first spacing edge 372 and the second spacing edge 373, and limits the first pipe body 31 and the limiting portion 13 together, and the second pipe body 32 and the reflective layer 36 together. It may be understood that the first pipe body 31 and the second pipe body 32 may be fixed to corresponding positions on the mounting base 37 by using a fixing structure.

The present application may further provide a heating component according to a fifth embodiment. The heating component differs from the heating component according to the first embodiment in the arrangement manner of a connection portion.

Specifically, in this embodiment, a heating element includes the connection portion that electrically connects one end of at least two heating portions. That is, the connection portion is only arranged at one end of the heating portions and electrically connects one end of the at least two heating portions.

In this embodiment, a heating element may include two heating portions. The two heating portions are arranged at an interval. The connection portion electrically connects one end of the two heating portions, and the other end of the two heating portions becomes a free end. A limiting portion may be arranged at the free end of the two heating portions, two conductive portions may be arranged, and the two conductive portions are connected to the limiting portion at an interval. The limiting portion may include two limiting jaws. The two limiting jaws are respectively connected to the free ends of the two heating portions. The two conductive portions may be respectively connected to the two limiting jaws.

In some other embodiments, the heating element may include three or more heating portions. Free ends of some of the heating portions may be directly connected together, to form two free ends, thereby equally implementing the arrangement of the limiting portion and the conductive portions.

The present application further provides an aerosol generating device. The aerosol generating device includes a heating component 10 and a power supply component configured to supply power to the heating component 10. The heating component 10 may be the one 10 in the above embodiments.

It may be understood that, when two electrodes of the heating component 10 are respectively a conductive rod 15 and a conductive portion 14, the power supply component is connected to the conductive rod 15 and the conductive portion 14 to supply power to the heating component 10. When two electrodes of the heating component 10 are two conductive portions 14, the power supply component is connected to the two conductive portions 14 to supply power to the heating component 10. When two electrodes of the heating component 10 are two limiting portions 13, the power supply component is connected to the two limiting portions 13 to supply power to the heating component 10.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating component, comprising:
a heating element; and
a pipe body,
wherein the heating element comprises a heating main body configured to generate infrared light in a powered-on state,
wherein the heating main body is arranged in a hollowed-out cylindrical shape and is spaced apart from the pipe body,
wherein the pipe body is configured to allow the infrared light to pass through, and
wherein a transmittance of the pipe body to infrared light at wavelengths of 2-4.75 μm is more than or equal to 50%.

2. The heating component of claim 1, wherein the heating main body comprises a hollowed-out portion and at least one heating portion,
wherein the at least one heating portion comprises an infrared light radiating layer, and
wherein the infrared light radiating layer is arranged on a surface of the at least one heating portion opposite to the pipe body.

3. The heating component of claim 2, wherein the at least one heating portion comprises at least two heating portions, and
wherein the hollowed-out portion is located between the at least two heating portions.

4. The heating component of claim 3, wherein the at least two heating portions are arranged in a strip shape, and
wherein each heating portion of the at least two heating portions is arranged circumferentially.

5. The heating component of claim 4, wherein the at least two heating portions are in a linear shape, a bent shape, or a spiral shape.

6. The heating component of claim 4, wherein the at least two heating portions have a same shape, are arranged in parallel circumferentially, and are parallel to a central axis of the heating main body.

7. The heating component of claim 3, wherein at least some heating portions of the at least two heating portions are parallel to one another, or
wherein at least some heating portions of the at least two heating portions are inclined relative to each other. or
wherein at least some heating portions of the at least two heating portions are intersected, or the at least two heating portions are interlaced into a mesh.

8. The heating component of claim 3, wherein the heating element comprises a connection portion electrically connecting one end of the at least two heating portions.

9. The heating component of claim 3, wherein the heating element comprises connection portions connecting the at least two heating portions into one piece and electrically connecting the at least two heating portions, and
wherein the connection portions are respectively arranged at two ends of the heating main body in an axial direction.

10. The heating component of claim 9, wherein the heating element comprises a conductive limiting portion configured to match the pipe body and conductively connect to the at least two heating portions.

11. The heating component of claim 10, wherein the conductive limiting portion comprises a limiting portion on the connection portion at least arranged on one end, and
wherein the limiting portion extends to an end away from the heating main body.

12. The heating component of claim 11, wherein the limiting portion comprises at least two limiting jaws arranged at an interval in a circumferential direction, and
wherein the at least two limiting jaws are in contact with a pipe wall of the pipe body.

13. The heating component of claim 11, wherein the limiting portion is arranged on the connection portion at one end, and
wherein the limiting portion is at least partially farther from a central axis of the heating main body than the at least two heating portions in a radial direction.

14. The heating component of claim 13, wherein an accommodating cavity configured to accommodate the heating element is formed in the pipe body,
wherein the heating element is arranged in the accommodating cavity,
wherein the at least two heating portions are spaced apart from the pipe wall of the pipe body, and
wherein the limiting portion is in contact fit with the pipe wall.

15. The heating component of claim 14, wherein the pipe body comprises a tubular portion and a pointed top structure arranged at one end of the tubular portion in the axial direction, and
wherein the tubular portion and the pointed top structure together define the accommodating cavity.

16. The heating component of claim 15, further comprising:
at least one conductive portion connected to the limiting portion and extending out from an end of the tubular portion opposite the pointed top structure.

17. The heating component of claim 16, wherein the at least one conductive portion comprises only one conductive portion,
wherein the conductive limiting portion comprises a fixing hole formed on an other connection portion,
wherein the heating component comprises a conductive rod,
wherein the conductive rod is mounted in the pipe body through the fixing hole,
wherein one end of the conductive rod abuts against and is fixed to the pointed top structure, and
wherein an other end of the conductive rod extends out from an end of the tubular portion opposite the pointed top structure.

18. The heating component of claim 17, wherein the fixing hole is located in a central axis of the heating main body.

19. The heating component of claim 16, wherein the at least one conductive portion comprises two conductive portions,
wherein one end of the two conductive portions is connected to the limiting portion,
wherein the two conductive portions are arranged at an interval, and
wherein an other end of the two conductive portions extends out from an end of the tubular portion opposite the pointed top structure.

20. The heating component of claim 15, wherein an end of the tubular portion opposite the pointed top structure is turned up so as to form a turned-up portion configured for installation and fixation.

21. The heating component of claim 11, wherein the limiting portions are respectively arranged on the connection portions at two ends and are at least partially closer to a central axis of the heating main body than the at least two heating portions in a radial direction.

22. An aerosol generating device, comprising:
the heating component of claim 1; and
a power supply component configured to supply power to the heating component.
